(19) United States
(12) Patent Application Publication
(10) Pub. No.: US 2025/0375068 A1
(43) Pub. Date: Dec. 11, 2025

(54) Foam Dispenser with Moveable Foam Generator

(71) Applicant: OP-HYGIENE IP GMBH, Niederbipp (CH)

(72) Inventors: Heiner OPHARDT, Arisdorf (CH); Andrew JONES, St. Anns (CA)

(21) Appl. No.: 19/223,497

(22) Filed: May 30, 2025

Related U.S. Application Data
(60) Provisional application No. 63/656,864, filed on Jun. 6, 2024.

(51) Int. Cl. A47K 5/14; A47K 5/12; A47K 5/13

(52) U.S. Cl. CPC A47K 5/14; A47K 5/13; A47K 5/1211

(57) ABSTRACT

A foam dispenser having a foam generator that is moveable within a foam generation chamber, and a pump mechanism that generates a positive pressure differential across the foam generation chamber during a discharge phase and a negative pressure differential across the foam generation chamber during a resupply phase. During the discharge phase, the positive pressure differential forces the foam generator into a first position, and forces foamable liquid and air to pass through the foam generator to generate foam. During the resupply phase, the negative pressure differential forces the foam generator into a second position, and atmospheric air is drawn into the foam dispenser without passing through the foam generator.

### RELATED APPLICATION

This application claims priority to the 6 Jun. 2024 filing date of U.S. Provisional Patent Application Ser. No. 63/656,864, which is incorporated herein by reference.

### FIELD OF THE INVENTION

This invention relates to foam dispensers, and more particularly to hand cleaning foam dispensers.

### BACKGROUND OF THE INVENTION

Foam dispensers are known that generate a hand cleaning foam by simultaneously passing air and a foamable liquid through a foam generator. The foam generator is typically formed by a porous material, such as a synthetic sponge, that thoroughly mixes the air and the foamable liquid to generate the foam. The foam generator may also include one or more screens or meshes.

Foam dispensers typically include an air chamber that needs to be replenished after each dispensing event. In some prior art devices, atmospheric air is drawn into the air chamber through the same outlet from which the foam is dispensed. In other prior art devices, a separate valve is used for fresh air introduction.

An advantage of drawing air in through the same outlet from which the foam is dispensed is that the air tends to draw any liquid and/or foam remaining in the outlet and/or foam generator back into the dispenser, thus preventing or reducing the risk of post dispense drip. This also avoids the need for a separate air valve, which tends to be made from soft materials that can be difficult and expensive to handle and assemble.

The applicant has, however, identified a number of disadvantages of prior art devices in which air is drawn in through the same outlet from which the foam is dispensed. For example, foam generators are inherently and intentionally restrictive of fluid flowing therethrough. As a result, drawing air in through a foam generator requires more energy than drawing air in through a separate air valve. This increased work means the pump or dispenser will generally require increased spring force (for manual dispensers) or power consumption (for touchless dispensers). Increased spring force will directly contribute to increased operation forces for manual dispensers, and increased power consumption will lead to reduced battery life for touchless dispensers.

Furthermore, even with increased spring force, the pump will tend to be slower to return than a similar valve equipped pump, and this slowness will limit the ability of users to take fast, multiple dispense operations. Drawing air in through the foam generator also tends to create foam product inside the air chamber, which can cause dosage inconsistency.

### SUMMARY OF THE INVENTION

To at least partially overcome some of the disadvantages of previously known systems, devices and methods, in one aspect the present invention provides a foam dispenser having a foam generator that is moveable within a foam generation chamber between a first position and a second position. At least one fluid passage is defined between the foam generator and the foam generation chamber. When the foam generator is in the first position, the at least one fluid passage is obstructed by the foam generator, and when the foam generator is in the second position, the at least one fluid passage is open. The dispenser also includes a pump mechanism that is configured to generate a positive pressure differential across the foam generation chamber during a discharge phase, and a negative pressure differential across the foam generation chamber during a resupply phase. During the discharge phase, the positive pressure differential forces the foam generator into the first position, and forces foamable liquid and air to pass through the foam generator to generate the foam, which is then dispensed via a foam outlet. During the resupply phase, the negative pressure differential forces the foam generator into the second position, and draws atmospheric air into the foam dispenser through the foam outlet and the at least one fluid passage.

The foam generator thus acts as a pneumatic valve, which is activated by the restriction inherent in the foam generator acting under the pressures/vacuum generated in the pump during use. This design allows for air to be drawn in through the foam outlet, while avoiding many of the disadvantages of the prior art.

For example, because the returning air is able to bypass the foam generator, the increased spring force and/or battery power that would otherwise be required to draw air through the foam generator can be avoided. Furthermore, the pump is not slowed down by having to draw air through the foam generator, and the creation of foam product inside the air chamber can be avoided.

The design is also able to maintain many of the advantages of prior art systems in which air is drawn in through the foam outlet. For example, the air drawn in through the foam outlet tends to draw any liquid and/or foam remaining in the outlet back into the dispenser, thus preventing or reducing the risk of post dispense drip. The design also avoids the need for a separate air valve.

Further aspects of the invention include:

A foam dispenser, which optionally incorporates one or more features of any one or more of the preceding and/or following aspects, comprising: at least one supply chamber; a foam outlet for discharging foam from the foam dispenser; a foam generation chamber having a fluid input side for receiving a foamable liquid and air from the at least one supply chamber, and a foam output side for delivering the foam to the foam outlet; a foam generator contained within the foam generation chamber; and a pump mechanism; wherein, on activation, the pump mechanism generates a positive pressure differential across the foam generation chamber during a discharge phase, and generates a negative pressure differential across the foam generation chamber during a resupply phase; wherein, during the discharge phase, a fluid pressure at the fluid input side of the foam generation chamber is greater than the fluid pressure at the foam output side of the foam generation chamber; wherein, during the resupply phase, the fluid pressure at the foam output side of the foam generation chamber is greater than the fluid pressure at the fluid input side of the foam generation chamber; wherein at least one fluid passage is defined between the foam generator and the foam generation chamber; wherein the foam generator is moveable within the foam generation chamber between a first position and a second position; wherein, when the foam generator is in the first position, the at least one fluid passage is obstructed by the foam generator; wherein, when the foam generator is in the second position, the at least one fluid passage is open; wherein, during the discharge phase, the positive pressure differential forces the foam generator into the first position, and forces the foamable liquid and the air to pass through the foam generator to generate the foam; and wherein, during the resupply phase, the negative pressure differential forces the foam generator into the second position, and draws atmospheric air into the foam dispenser through the foam outlet and the at least one fluid passage.

A foam dispenser, which optionally incorporates one or more features of any one or more of the preceding and/or following aspects, wherein the at least one supply chamber comprises a liquid chamber for containing the foamable liquid and an air chamber for containing the air.

A foam dispenser, which optionally incorporates one or more features of any one or more of the preceding and/or following aspects, wherein the pump mechanism comprises a piston member and a piston chamber forming body; wherein the liquid chamber is defined at least in part by the piston member and the piston chamber forming body; wherein the air chamber is defined at least in part by the piston member and the piston chamber forming body; wherein the piston member is moveable relative to the piston chamber forming body between an extended position and a retracted position; wherein, during the discharge phase, the piston member moves from the extended position towards the retracted position, which compresses both the liquid chamber and the air chamber; and wherein, during the resupply phase, the piston member moves from the retracted position towards the extended position, which enlarges both the liquid chamber and the air chamber.

A foam dispenser, which optionally incorporates one or more features of any one or more of the preceding and/or following aspects, wherein, during the resupply phase, the movement of the piston member from the retracted position towards the extended position generates a vacuum within the air chamber, which draws the atmospheric air into the air chamber through the foam outlet and the at least one fluid passage.

A foam dispenser, which optionally incorporates one or more features of any one or more of the preceding and/or following aspects, further comprising a fluid reservoir containing a supply of the foamable liquid; wherein, during the resupply phase, the movement of the piston member from the retracted position towards the extended position generates a vacuum within the liquid chamber, which draws the foamable liquid into the liquid chamber from the fluid reservoir.

A foam dispenser, which optionally incorporates one or more features of any one or more of the preceding and/or following aspects, wherein the foam generator comprises a porous material.

A foam dispenser, which optionally incorporates one or more features of any one or more of the preceding and/or following aspects, wherein the foam generator is arranged such that gravity biases the foam generator towards the first position.

A foam dispenser, which optionally incorporates one or more features of any one or more of the preceding and/or following aspects, wherein the foam generation chamber has an outer wall; and wherein a lateral width of the outer wall is greater at the fluid input side of the foam generation chamber than at the foam output side of the foam generation chamber.

A foam dispenser, which optionally incorporates one or more features of any one or more of the preceding and/or following aspects, wherein, when the foam generator is at the first position, the foam generator sealingly engages with the outer wall at the foam output side of the foam generation chamber.

A foam dispenser, which optionally incorporates one or more features of any one or more of the preceding and/or following aspects, wherein, when the foam generator is at the second position, the foam generator is spaced from the outer wall at the foam output side of the foam generation chamber.

A foam dispenser, which optionally incorporates one or more features of any one or more of the preceding and/or following aspects, wherein the at least one fluid passage is defined at least in part between an outer surface of the foam generator and the outer wall of the foam generation chamber.

A foam dispenser, which optionally incorporates one or more features of any one or more of the preceding and/or following aspects, wherein the foam generation chamber has at least one guide rib that engages with the foam generator to maintain the foam generator in a selected orientation relative to the foam generation chamber.

A foam dispenser, which optionally incorporates one or more features of any one or more of the preceding and/or following aspects, wherein the fluid input side of the foam generation chamber has a stop shoulder; wherein the foam generator engages with the stop shoulder when at the second position; and wherein the stop shoulder has at least one passageway that allows fluid to flow between the foam generator and the stop shoulder when the foam generator is at the second position.

A foam dispenser, which optionally incorporates one or more features of any one or more of the preceding and/or following aspects, wherein the foam dispenser is configured so that all of the atmospheric air drawn into the foam dispenser is drawn in through the foam outlet.

A foam dispenser, which optionally incorporates one or more features of any one or more of the preceding and/or following aspects, wherein the foam dispenser is a hand cleaning foam dispenser.

A method of operating a foam dispenser, which optionally incorporates one or more features of any one or more of the preceding and/or following aspects, the foam dispenser comprising: a foam outlet for discharging foam; a foam generation chamber having a fluid input side and a foam output side; a foam generator contained within the foam generation chamber; and a pump mechanism; wherein at least one fluid passage is defined between the foam generator and the foam generation chamber; wherein the foam generator is moveable within the foam generation chamber between a first position and a second position; wherein, when the foam generator is in the first position, the at least one fluid passage is obstructed by the foam generator; and wherein, when the foam generator is in the second position, the at least one fluid passage is open; the method comprising: using the pump mechanism to generate a positive pressure differential across the foam generation chamber, which forces the foam generator into the first position, and forces foamable liquid and air to pass through the foam generator to generate the foam; and using the pump mechanism to generate a negative pressure differential across the foam generation chamber, which forces the foam generator into the second position, and draws atmospheric air into the foam dispenser through the foam outlet.

### BRIEF DESCRIPTION OF THE DRAWINGS

Further aspects and advantages of the invention will appear from the following description taken together with the accompanying drawings, in which:

FIG. 1 is a partially exploded perspective view of a foam dispenser in accordance with a preferred embodiment of the present invention;

FIG. 2 is a perspective view of a foam pump of the foam dispenser shown in FIG. 1;

FIG. 3 is a cross-sectional side view of the foam pump shown in FIG. 2, with the pump shown in an extended position;

FIG. 4 is a cross-sectional side view of the foam pump shown in FIG. 2, with the pump shown in an intermediate position during a discharge stroke;

FIG. 5 is a cross-sectional side view of the foam pump shown in FIG. 2, with the pump shown in a retracted position;

FIG. 6 is a cross-sectional side view of the foam pump shown in FIG. 2, with the pump shown in an intermediate position during a resupply stroke;

FIG. 7 is a cross-sectional perspective view showing a foam generator and a foam generation chamber of the foam pump shown in FIG. 2;

FIG. 8 is a side view of a first alternative foam generator that could be incorporated into the foam pump shown in FIG. 2; and

FIG. 9 is a side view of a second alternative foam generator that could be incorporated into the foam pump shown in FIG. 2.

### DETAILED DESCRIPTION OF THE DRAWINGS

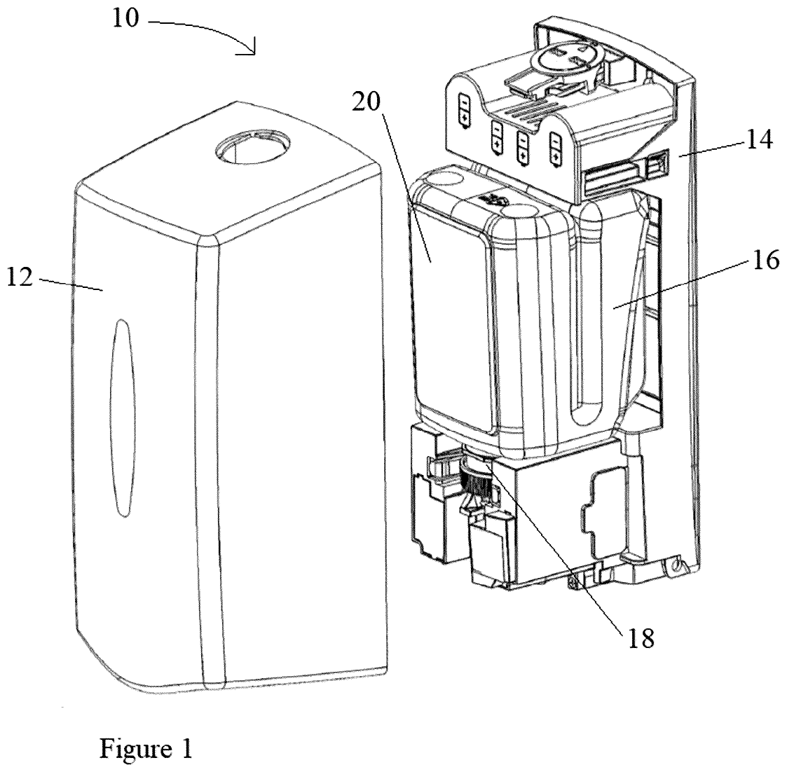

FIG. 1 shows a foam dispenser 10 in accordance with a preferred embodiment of the present invention. The foam dispenser 10 includes a removable cover 12, a housing 14, a fluid reservoir 16, and a foam pump 18.

The fluid reservoir 16 contains a supply of a foamable hand cleaning fluid, and is attached to the foam pump 18 to form a replaceable cartridge 20. The replaceable cartridge 20 is received by the housing 14. The cover 12 is attachable to the housing 14 to hide the replaceable cartridge 20 and to prevent unauthorized tampering with the dispenser 10. The housing 14 is configured to touchlessly activate the foam pump 18 when a user places their hand below the dispenser 10, as is known in the art.

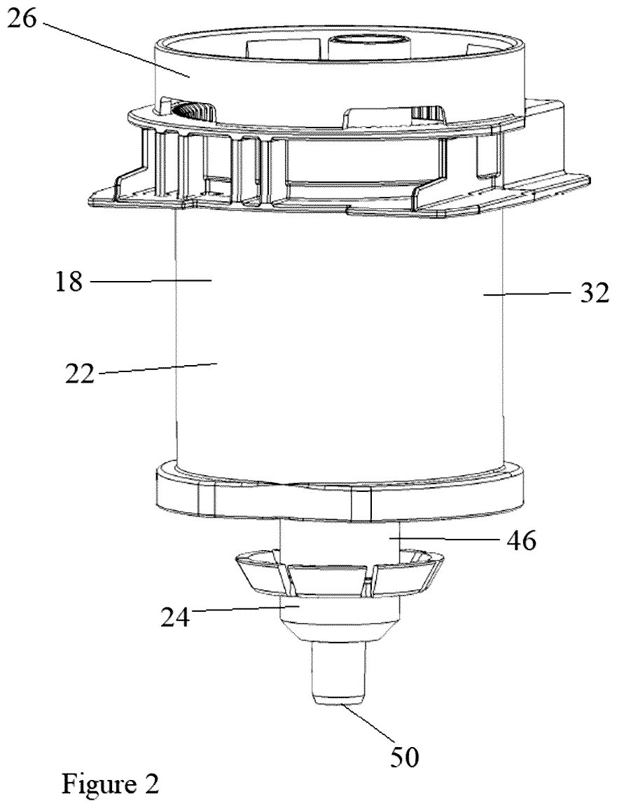

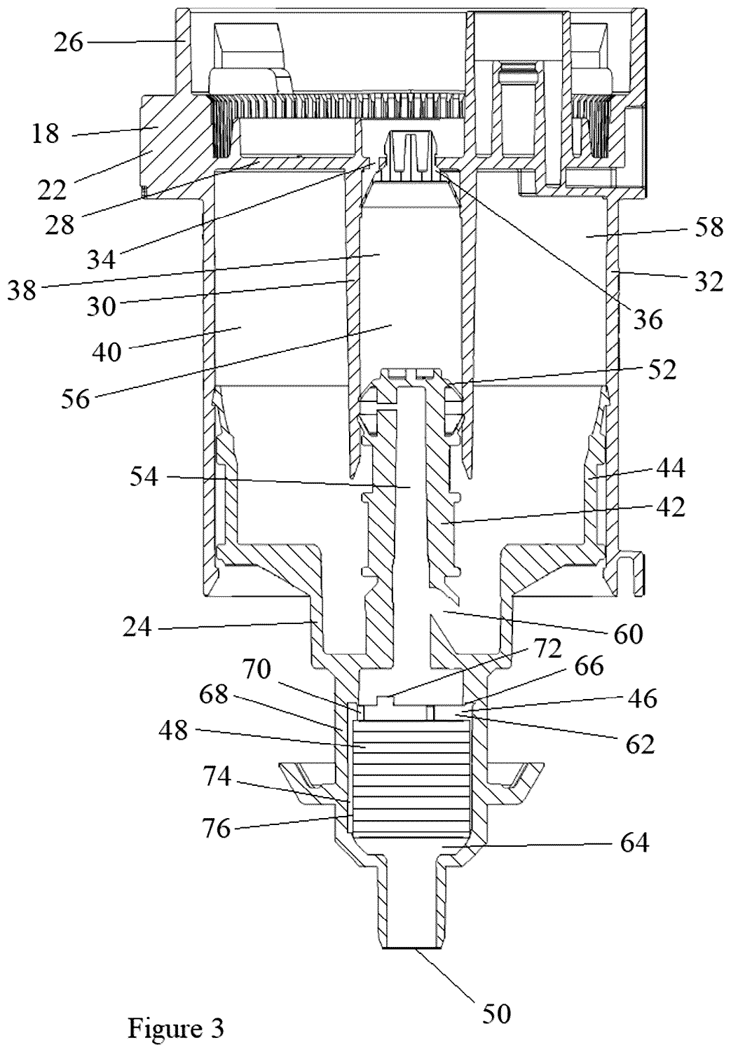

As can be seen in FIGS. 2 and 3, the foam pump 18 has a piston chamber forming body 22 and a piston member 24. The piston chamber forming body 22 includes a reservoir attachment portion 26, a top wall 28, a cylindrical inside wall 30, and a cylindrical outside wall 32. The reservoir attachment portion 26 is configured to attach to the fluid reservoir 16 for receiving the foamable liquid therefrom. The top wall 28 extends horizontally across the piston chamber forming body 22 and has a central inlet opening 34 that carries a one-way inlet valve 36.

The cylindrical inside wall 30 surrounds the central inlet opening 34 and extends downwardly from the top wall 28. The cylindrical inside wall 30 defines a liquid compartment 38 having an open bottom end.

The cylindrical outside wall 32 is spaced laterally outwardly from the cylindrical inside wall 30, and extends downwardly from the top wall 28. The cylindrical outside wall 32 defines an air compartment 40 having an open bottom end.

The piston member 24 includes a liquid piston forming body 42, an air piston forming body 44, a foam generation chamber 46, a foam generator 48, and a foam outlet 50. The liquid piston forming body 42 is a stem-like structure that extends into the liquid compartment 38 through the open bottom end thereof. The top of the liquid piston forming body 42 has a piston inlet valve 52. An internal channel 54 extends down through the liquid piston forming body 42 from the piston inlet valve 52 to the foam generation chamber 46. A variable volume liquid chamber 56 is defined between the piston inlet valve 52, the cylindrical inside wall 30, and the one-way inlet valve 36.

The air piston forming body 44 is positioned laterally outwardly from the liquid piston forming body 42, and extends into the air compartment 40 through the open bottom end thereof. The air piston forming body 44 is configured to sealingly engage with the inner surface of the cylindrical outside wall 32, so as to define a variable volume air chamber 58 between the air piston forming body 44, the cylindrical outside wall 32, and the top wall 28. One or more air passages 60 fluidly connect the air chamber 58 to the internal channel 54 of the liquid piston forming body 42.

The foam generation chamber 46 has a fluid input side 62 that is in fluid communication with the bottom of the internal channel 54, and a foam output side 64 that is in fluid communication with the foam outlet 50. The foam generation chamber 46 has a stop shoulder 66 at the fluid input side 62, and a cylindrical outer wall 68 that extends downwardly from the stop shoulder 66. At the fluid input side 62, the cylindrical outer wall 68 has a lateral width that is greater than the lateral width of the stop shoulder 66. As can be seen in FIG. 3, the stop shoulder 66 has at least one cut-out portion 72.

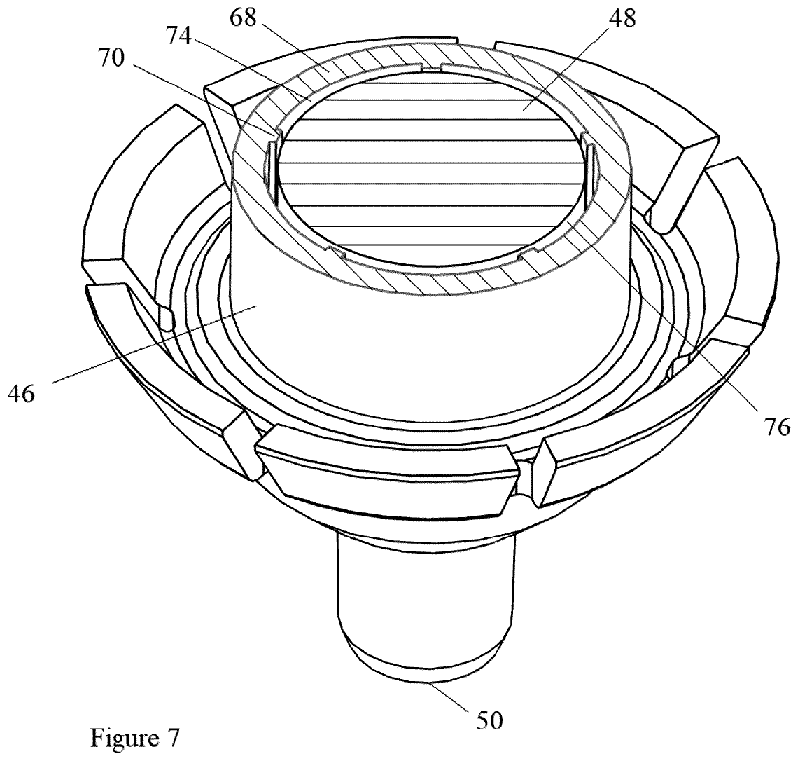

At the bottom of the foam generation chamber 46, the cylindrical outer wall 68 tapers laterally inwardly, such that the lateral width of the outer wall 68 is greater at the fluid input side 62 than it is at the foam output side 64. As is best shown in FIG. 7, the foam generation chamber 46 also has a plurality of vertical guide ribs 70 that extend laterally inwardly from the outer wall 68. The guide ribs 70 extend from the stop shoulder 66 down to the top of the tapered section of the outer wall 68.

The foam generator 48 is a cylindrical structure that is located within the foam generation chamber 46, and is formed from a material or materials that are selected for the generation of foam. For example, the foam generator 48 is preferably made from a porous material, such as a synthetic sponge. Other materials such as one or more metallic screens or meshes may also be incorporated into the foam generator 48.

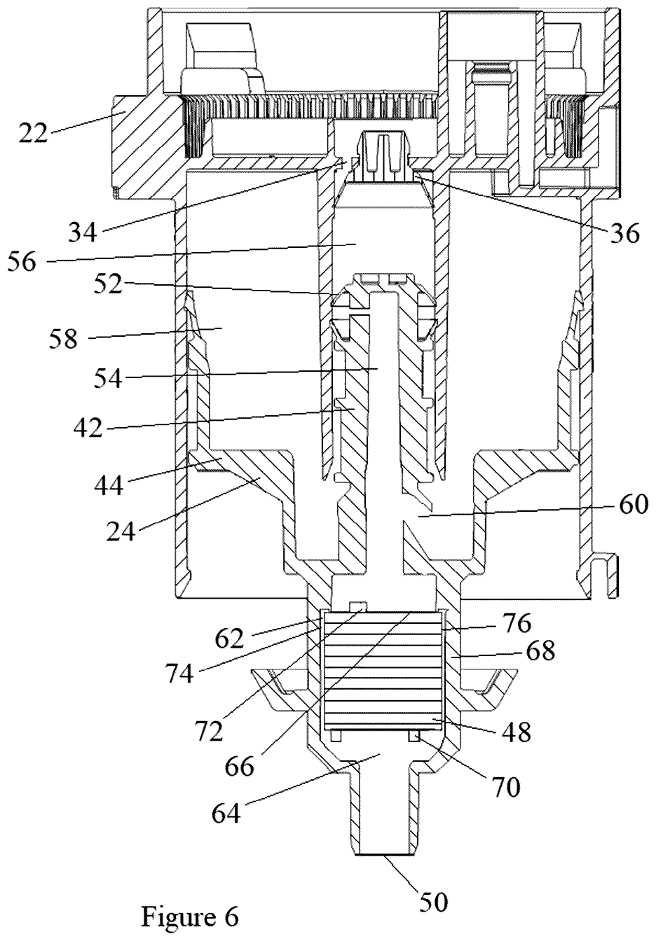

As can be seen in FIG. 3, the foam generator 48 has a lateral width that is greater than the lateral width of the stop shoulder 66, smaller than the lateral width of the outer wall 68 at the fluid input side 62, and greater than the lateral width of the outer wall 68 at the foam output side 64. The foam generator 48 also has a vertical height that is smaller than the vertical distance between the stop shoulder 66 at the fluid input side 62 and the bottom of the foam generation chamber 46 at the foam output side 64. This allows the foam generator 48 to move vertically within the foam generation chamber 46 between a first position, shown in FIG. 3, in which the foam generator 48 engages with the tapered portion of the outer wall 68 at the foam output side 64 of the foam generation chamber 46, and a second position, shown in FIG. 6, in which the foam generator 48 engages with the stop shoulder 66 at the fluid input side 62 of the foam generation chamber 46, and is spaced from the tapered portion of the outer wall 68 at the foam output side 64 of the foam generation chamber 46. The guide ribs 70 preferably help to maintain the foam generator 48 in the desired vertical orientation as it moves between the first and second positions.

As can be seen in FIG. 7, at least one fluid passage 74 is defined between the foam generation chamber 46 and an outer surface 76 of the foam generator 48. When the foam generator 48 is in the second position shown in FIG. 6, the fluid passage 74 provides a path for fluid to flow through the foam generation chamber 46 between the fluid inlet side 62 and the foam output side 64 without passing through the foam generator 48. In particular, when in the second position, the foam generator 48 is spaced upwardly away from the tapered bottom portion of the outer wall 68 at the foam output side 64, which allows fluid to pass unimpeded through the foam output side 64; in the middle of the foam generation chamber 46, the outer surface 76 of the foam generator 48 is spaced laterally inwardly from the outer wall 68, which allows fluid to flow between the foam generator 48 and the outer wall 68; and at the fluid input side 62, fluid is able to flow past the foam generator 48 through the cut-outs 72 in the stop shoulder 66.

When the foam generator 48 is in the first position shown in FIG. 3, the bottom of the foam generator 48 sealingly engages with the tapered bottom portion of the outer wall 68. This obstructs the fluid passage 74, such that any fluid flowing between the fluid inlet side 62 and the foam output side 64 of the foam generation chamber 46 must pass through the foam generator 48.

The operation of the dispenser 10 will now be described with reference to the Figures. In order to activate the dispenser 10, a user places their hand below the foam outlet 50. The hand is detected by a suitable sensor, such as a proximity sensor, which triggers the activation of an electronic pump activation mechanism (not shown), as is known in the art. The electronic pump activation mechanism activates the foam pump 18 by moving the piston member 24 relative to the piston chamber forming body 22 in a discharge stroke and a resupply stroke.

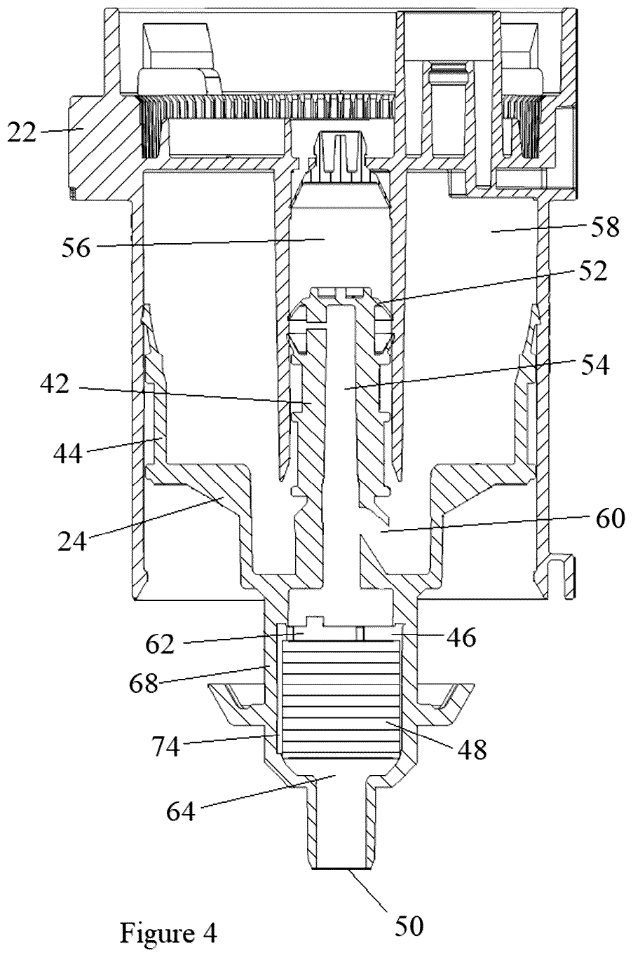

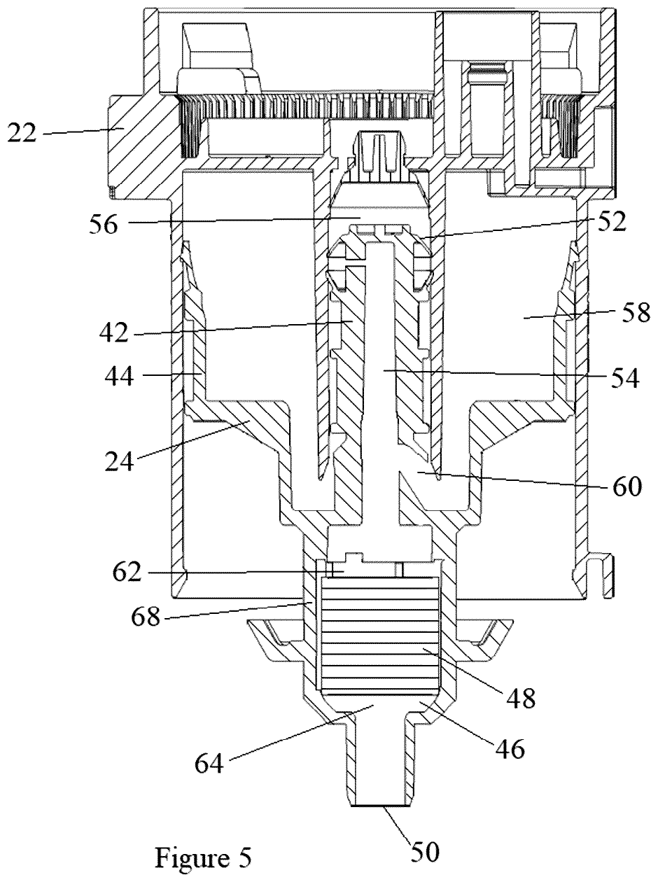

During the discharge stroke, the piston member 24 moves from the extended position shown in FIG. 3, through the intermediate position shown in FIG. 4, to the retracted position shown in FIG. 5. During the resupply stroke, the piston member 24 moves from the retracted position shown in FIG. 5, through the intermediate position shown in FIG. 6, and back to the extended position shown in FIG. 3.

When in the extended position shown in FIG. 3, the liquid chamber 56 contains a supply of the foamable hand cleaning liquid, the air chamber 58 contains a supply of air, and the foam generator 48 rests at the first position under the force of gravity.

As the piston member 24 moves upwardly to the intermediate position shown in FIG. 4, the upwards movement of the liquid piston forming body 42 compresses the liquid chamber 56, which causes the foamable liquid to flow from the liquid chamber 56, through the piston inlet valve 52, and into the internal channel 54. At the same time, the upwards movement of the air piston forming body 44 compresses the air chamber 58, forcing air to flow from the air chamber 58, through the air passage 60, and into the internal channel 54.

The influx of liquid and air into the internal channel 54 during the discharge stroke creates a positive pressure differential across the foam generation chamber 46, with the fluid pressure at the fluid input side 62 being greater than the fluid pressure at the foam output side 64. The positive pressure differential pushes the foam generator 48 into sealing engagement with the tapered bottom portion of the outer wall 68 in the first position, thereby obstructing the fluid passage 74.

The positive pressure differential also forces the liquid and air to pass through the foam generation chamber 46 from the fluid input side 62 to the foam output side 64. With the fluid passage 74 obstructed by the foam generator 48, the liquid and air are forced to pass through the foam generator 48, which thoroughly mixes the liquid and air, generating a foam at the foam output side 64. The foam is then discharged from the foam outlet 50 and onto the user's hand. The discharge stroke ends when the piston member 24 reaches the retracted position shown in FIG. 5.

During the resupply stroke, as the piston member 24 moves downwardly to the intermediate position shown in FIG. 6, the downwards movement of the liquid piston forming body 42 expands the liquid chamber 56, which generates a vacuum within the liquid chamber 56. The vacuum draws liquid from the fluid reservoir 16 into the liquid chamber 56 through the one-way inlet valve 36. The piston inlet valve 52 prevents fluid from being drawn from the internal channel 54 into the liquid chamber 56.

At the same time, the downwards movement of the air piston forming body 44 expands the air chamber 58, generating a vacuum that draws fluid from the internal chamber 54 into the air chamber 58 through the air passage 60. This produces a negative pressure differential across the foam generation chamber 46, with the fluid pressure at the foam output side 64 being greater than the fluid pressure at the fluid input side 62. The negative pressure differential forces the foam generator 48 upwards into the second position shown in FIG. 6.

The negative pressure differential furthermore draws atmospheric air into the foam outlet 50, which passes through the foam generation chamber 46 and into the air chamber 58. With the foam generator 48 at the second position during the resupply stroke, the air is able to flow through the fluid passage 74 without passing through the foam generator 48. As a result, no foam is generated during the resupply stroke, and the air drawn into the dispenser 10 encounters minimal resistance. At the end of the resupply stroke, the piston member 24 is back at the extended position shown in FIG. 3, and the liquid chamber 56 and the air chamber 58 are filled with liquid and air, respectively.

It will be understood that, although various features of the invention have been described with respect to one or another of the embodiments of the invention, the various features and embodiments of the invention may be combined or used in conjunction with other features and embodiments of the invention as described and illustrated herein.

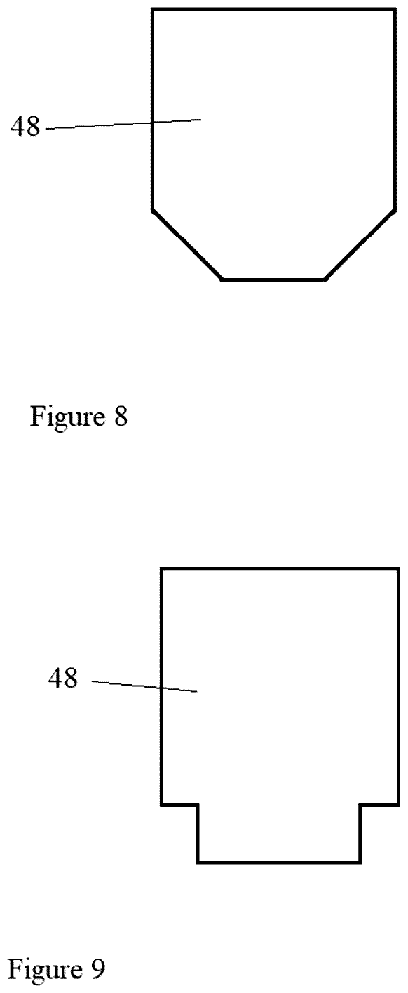

The invention is not limited to the particular structures of the preferred embodiments that have been shown in the drawings. Rather, any functionally equivalent structures could be used. For example, two alternative structures for the foam generator 48 are shown in FIGS. 8 and 9. In FIG. 8, the foam generator 48 has a tapered bottom end, which is shaped to match the tapered bottom portion of the outer wall 68 of the foam generation chamber 46. In FIG. 9, the foam generator 48 has a stepped bottom portion, which could for example be configured to mate with a corresponding stepped portion at the bottom of the foam generation chamber 46. Any suitable shape and structure of the foam generator 48 and foam generation chamber 46 could be used. The foam generator 48 may for example include flanged surfaces to provide a larger surface area to allow easier movement of the valve under lower pressures and/or speeds. As well the overall travel distance of the foam generator 48 may be more or less than shown.

The foam pump 18, which is also referred to herein as the pump mechanism 18, could also have any suitable structure, and is not limited to the particular structure shown in the drawings. For example, the fluid pump 18 could be configured to be manually activated, rather than being touchlessly activated as described in the preferred embodiments.

The dispenser 10 could optionally incorporate any desired features known in the art, including for example one or more features from any one or more of: U.S. Pat. No. 8,245,877 to Ophardt, issued Aug. 21, 2012; U.S. Pat. No. 8,113,388 to Ophardt et al., issued Feb. 14, 2012; U.S. Pat. No. 8,091,739 to Ophardt et al., issued Jan. 10, 2012; U.S. Pat. No. 7,748,573 to Anhuf et al., issued Jul. 6, 2010; U.S. Pat. No. 7,984,825 to Ophardt et al., issued Jul. 26, 2011; U.S. Pat. No. 8,684,236 to Ophardt, issued Apr. 1, 2014; U.S. Pat. No. 5,373,970 to Ophardt, issued Dec. 20, 1994; U.S. Pat. No. 5,836,482 to Ophardt et al., issued Nov. 17, 1998; U.S. Pat. No. 10,893,780 to Ophardt et al., issued 19 Jan. 2021; and U.S. Pat. No. 9,682,390 to Ophardt et al., issued Jun. 20, 2017, which are incorporated herein by reference.

Any suitable hand cleaning liquid could be used, including for example foamable soap, sanitizer, and/or disinfectant.

The term “cut-out” 72 as used herein refers structurally to a passageway that is defined through the stop shoulder 66, so as to allow fluid to bypass the foam generator 48 when the foam generator 48 is at the second position. The term “cut-out” 72 is not intended to imply or require that the cut-out 72 is formed by physically cutting out a portion of the stop shoulder 66. Rather, any suitable method of producing a passageway through the stop shoulder 66 could be used. For example, in preferred embodiments, the stop shoulder 66 and its cut-out 72 or cut-outs 72 are formed by a molding process.

Although this disclosure has described and illustrated certain preferred embodiments of the invention, it is to be understood that the invention is not restricted to these particular embodiments. Rather, the invention includes all embodiments which are functional or mechanical equivalents of the specific embodiments and features that have been described and illustrated herein.

We claim:

1. A foam dispenser comprising:
at least one supply chamber;
a foam outlet for discharging foam from the foam dispenser;
a foam generation chamber having a fluid input side for receiving a foamable liquid and air from the at least one supply chamber, and a foam output side for delivering the foam to the foam outlet;
a foam generator contained within the foam generation chamber; and
a pump mechanism;
wherein, on activation, the pump mechanism generates a positive pressure differential across the foam generation chamber during a discharge phase, and generates a negative pressure differential across the foam generation chamber during a resupply phase;
wherein, during the discharge phase, a fluid pressure at the fluid input side of the foam generation chamber is greater than the fluid pressure at the foam output side of the foam generation chamber;
wherein, during the resupply phase, the fluid pressure at the foam output side of the foam generation chamber is greater than the fluid pressure at the fluid input side of the foam generation chamber;
wherein at least one fluid passage is defined between the foam generator and the foam generation chamber;
wherein the foam generator is moveable within the foam generation chamber between a first position and a second position;
wherein, when the foam generator is in the first position, the at least one fluid passage is obstructed by the foam generator;
wherein, when the foam generator is in the second position, the at least one fluid passage is open;
wherein, during the discharge phase, the positive pressure differential forces the foam generator into the first position, and forces the foamable liquid and the air to pass through the foam generator to generate the foam; and
wherein, during the resupply phase, the negative pressure differential forces the foam generator into the second position, and draws atmospheric air into the foam dispenser through the foam outlet and the at least one fluid passage.

2. The foam dispenser according to claim 1, wherein the at least one supply chamber comprises a liquid chamber for containing the foamable liquid and an air chamber for containing the air.

3. The foam dispenser according to claim 2, wherein the pump mechanism comprises a piston member and a piston chamber forming body;
wherein the liquid chamber is defined at least in part by the piston member and the piston chamber forming body;
wherein the air chamber is defined at least in part by the piston member and the piston chamber forming body;
wherein the piston member is moveable relative to the piston chamber forming body between an extended position and a retracted position;
wherein, during the discharge phase, the piston member moves from the extended position towards the retracted position, which compresses both the liquid chamber and the air chamber; and
wherein, during the resupply phase, the piston member moves from the retracted position towards the extended position, which enlarges both the liquid chamber and the air chamber.

4. The foam dispenser according to claim 3, wherein, during the resupply phase, the movement of the piston member from the retracted position towards the extended position generates a vacuum within the air chamber, which draws the atmospheric air into the air chamber through the foam outlet and the at least one fluid passage.

5. The foam dispenser according to claim 3, further comprising a fluid reservoir containing a supply of the foamable liquid;
wherein, during the resupply phase, the movement of the piston member from the retracted position towards the extended position generates a vacuum within the liquid chamber, which draws the foamable liquid into the liquid chamber from the fluid reservoir.

6. The foam dispenser according to claim 1, wherein the foam generator comprises a porous material.

7. The foam dispenser according to claim 1, wherein the foam generator is arranged such that gravity biases the foam generator towards the first position.

8. The foam dispenser according to claim 1, wherein the foam generation chamber has an outer wall; and
wherein a lateral width of the outer wall is greater at the fluid input side of the foam generation chamber than at the foam output side of the foam generation chamber.

9. The foam dispenser according to claim 8, wherein, when the foam generator is at the first position, the foam generator sealingly engages with the outer wall at the foam output side of the foam generation chamber.

10. The foam dispenser according to claim 9, wherein, when the foam generator is at the second position, the foam generator is spaced from the outer wall at the foam output side of the foam generation chamber.

11. The foam dispenser according to claim 10, wherein the at least one fluid passage is defined at least in part between an outer surface of the foam generator and the outer wall of the foam generation chamber.

12. The foam dispenser according to claim 11, wherein the foam generation chamber has at least one guide rib that engages with the foam generator to maintain the foam generator in a selected orientation relative to the foam generation chamber.

13. The foam dispenser according to claim 1, wherein the fluid input side of the foam generation chamber has a stop shoulder;
wherein the foam generator engages with the stop shoulder when at the second position; and
wherein the stop shoulder has at least one passageway that allows fluid to flow between the foam generator and the stop shoulder when the foam generator is at the second position.

14. The foam dispenser according to claim 1, wherein the foam dispenser is configured so that all of the atmospheric air drawn into the foam dispenser is drawn in through the foam outlet.

15. The foam dispenser according to claim 1, wherein the foam dispenser is a hand cleaning foam dispenser.

16. The foam dispenser according to claim 4, further comprising a fluid reservoir containing a supply of the foamable liquid;
wherein, during the resupply phase, the movement of the piston member from the retracted position towards the extended position generates a vacuum within the liquid chamber, which draws the foamable liquid into the liquid chamber from the fluid reservoir.

17. The foam dispenser according to claim 16, wherein the foam generator comprises a porous material; and
wherein the foam generator is arranged such that gravity biases the foam generator towards the first position.

18. The foam dispenser according to claim 17, wherein the foam generation chamber has an outer wall;
wherein a lateral width of the outer wall is greater at the fluid input side of the foam generation chamber than at the foam output side of the foam generation chamber;
wherein, when the foam generator is at the first position, the foam generator sealingly engages with the outer wall at the foam output side of the foam generation chamber;
wherein, when the foam generator is at the second position, the foam generator is spaced from the outer wall at the foam output side of the foam generation chamber;
wherein the at least one fluid passage is defined at least in part between an outer surface of the foam generator and the outer wall of the foam generation chamber; and
wherein the foam generation chamber has at least one guide rib that engages with the foam generator to maintain the foam generator in a selected orientation relative to the foam generation chamber.

19. The foam dispenser according to claim 18, wherein the fluid input side of the foam generation chamber has a stop shoulder;
wherein the foam generator engages with the stop shoulder when at the second position; and
wherein the stop shoulder has at least one passageway that allows fluid to flow between the foam generator and the stop shoulder when the foam generator is at the second position.

20. The foam dispenser according to claim 19, wherein the foam dispenser is configured so that all of the atmospheric air drawn into the foam dispenser is drawn in through the foam outlet; and
wherein the foam dispenser is a hand cleaning foam dispenser.
